(19) United States
(12) Patent Application Publication
(10) Pub. No.: US 2017/0282769 A1
(43) Pub. Date: Oct. 5, 2017

(54) UPHOLSTERED ELEMENT FOR A VEHICLE SEAT

(71) Applicant: Ford Global Technologies, LLC, Dearborn, MI (US)

(72) Inventor: Joerg Stephan, Pulheim (DE)

(73) Assignee: Ford Global Technologies, LLC

(21) Appl. No.: 15/444,873

(22) Filed: Feb. 28, 2017

(30) Foreign Application Priority Data
Apr. 1, 2016 (DE) 102016205472.4

(51) Int. Cl. B60N 2/64; B60N 2/58

(52) U.S. Cl. CPC B60N 2/646; B60N 2/58

(57) ABSTRACT

An upholstered element for a vehicle seat, with a padded core and an upholstery covering arranged thereon, wherein the padded core has a concave region and the upholstery covering is connected inside the concave region to the padded core by way of at least two linear connecting devices, wherein at least one end region of one connecting device is close to another connecting device. In order to permit an improved connection of the padded core and upholstery covering, the at least one end region is spaced from the other connecting device by a connection-free region and runs at an angle to the other connecting device.

### FIELD OF THE INVENTION

The present invention relates to vehicle seats, and more particularly relates to an upholstered element for a vehicle seat.

### BACKGROUND OF THE INVENTION

Upholstered vehicle seats, e.g. for motor vehicles, generally comprise a padded core and an upholstery covering arranged thereon. The upholstery covering ensures a sturdy as well as a suitable optical and tactile surface of the seat, whilst the actual padding effect is based on the padded core which is typically made of foam. Inter alia, as a result of the partly complex form of the vehicle seat which follows, the ergonomy and design aspects, the upholstery covering normally has to be connected to the core not only along its edges, but also in the surfaces which lie in between order to fit sufficiently tight against the padded core.

For this it is usual to provide on the upholstery covering as well as on the padded core mutually corresponding fastening elements which in the assembled state engage in one another with form-fitting and/or force-fitting engagement. To this end, by way of example, wires can be fixed on the padded core and corresponding retaining elements of the upholstery covering engage on the wires. These retaining elements can be, by way of example, clip elements which are stitched on the upholstery covering or a further wire can be stitched on the upholstery covering and can be connected to the wire in the padding by a clip ring. In order to prevent the fastening elements from wearing out too much, normally a type of channel is molded into the padded core and accommodates the fastening elements at least in part.

Fastening elements of this kind which are normally arranged in strips or lines can be recognized relatively clearly from outside as a type of local constriction in the surface. It is thus not possible to adapt to a concave surface of the upholstered element which is by way of example uniformly curved. Apart from the optical appearance of the seat, the sitting comfort and wear behaviour of the core or upholstery covering can also be detrimentally affected.

U.S. Pat. No. 8,511,754 B2 shows an upholstered seat element for a vehicle seat. The seat element comprises a foam core with grooved indentations. An upholstery covering is applied to the foam core and is connected to the foam core via connecting devices which are arranged along the indentations. At the places where a foil-like seat occupancy sensor crosses a connecting zone of this kind there is at least one recess in the foam core into which the sensor can move with local compression of the foam core. According to one configuration, it is proposed that a wire associated with the cover and which is part of a connecting device is interrupted in the region of the sensor in order to prevent mechanical stress on the sensor.

U.S. Pat. No. 3,794,378 discloses a seat element with a cushion of elastomer which has at least one elongated indentation along its surface. An anchor element is fixedly connected to the bottom of the indentation. An upholstery covering has an elongated elastic restraining element which interacts with the anchor element via restraining means in order to hold the upholstery covering inside the indentation. The restraining element can be stitched by way of example to two abutting pieces of the upholstery covering and can have a strip from which outwardly directed hook elements extend on both sides to interact with inwardly directed elastic hook elements of the anchor element.

U.S. Pat. No. 7,585,025 B2 discloses a headrest for a vehicle seat having a padded core which has a connecting region for an upholstery covering. The upholstery covering is bag-shaped overall and can be drawn over the padded core. In the opening region there are two opposite ends of the upholstery covering which overlap each other in the closed position. Detent elements which are connected to the one end are guided here through holes provided in the other end and engage with a corresponding detent device which is connected to the padded core. On the one hand, a closure of the upholstery covering is hereby possible and, on the other hand, it can be held in a fluted region of the padded core adjacent to the latter.

It would be desirable to provide an improved attachment of the upholstery covering to the padded core of a vehicle seat, particularly with regard to improving a soft linear guide in the concave regions of the vehicle seat.

### SUMMARY OF THE INVENTION

According to one aspect of the present invention, an upholstered element for a vehicle seat is provided. The upholstered element for a vehicle seat includes a padded core having a concave region, and an upholstery covering arranged on the core and connected inside the concave region to the padded core by way of at least two linear connecting devices. At least one end region of one connecting device is close to another connecting device and is spaced from the other connecting device by a connection-free region and runs at an angle to the other connecting device.

According to another aspect of the present invention, an upholstered vehicle seat element is provided. The upholstered vehicle seat element includes a padded core having a concave region, and an upholstery covering arranged on the core. The upholstered vehicle seat element includes at least two linear connecting devices connecting the upholstery covering to the core inside the concave region. An end region of one connecting device is close to another connecting device and is spaced from the other connecting device by a connection-free region and runs at an angle to the other connecting device.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a front view of a back seat of a vehicle seat having an upholstered element according to the prior art;

FIG. 2 is a front view of a back seat of a vehicle seat having an upholstered element according to one embodiment of the present invention;

FIG. 3 is a cross-sectional view taken through line of FIG. 2; and

FIG. 4 is a perspective view of a vehicle seat with upholstered elements according to one embodiment of the present invention.

In the different figures the same parts are always provided with the same reference numerals, and are therefore as a rule only described once.

### DETAILED DESCRIPTION OF THE PREFERRED EMBODIMENTS

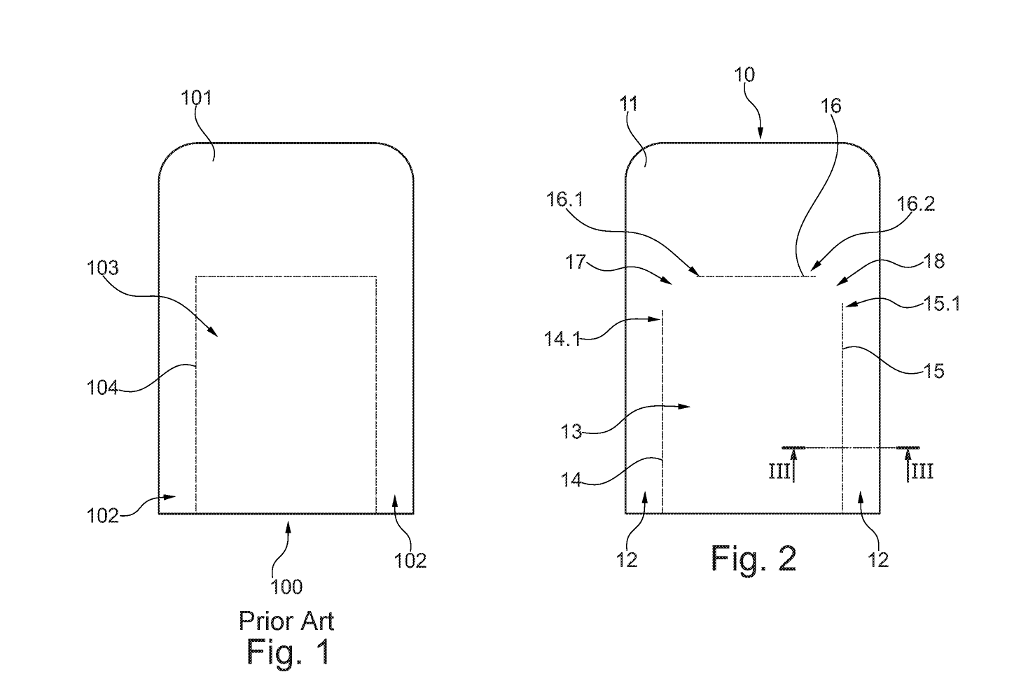

FIG. 1 shows in a heavily diagrammatic form a front view of a conventional seat back or backseat cushion 100 of a vehicle seat, by way of example for a passenger vehicle. An upholstery covering 101 is applied to a padded core, which is not covered and thus visible in this figure, and which has a concave region 103 between the two laterally projecting sidewalls 102. In order to ensure the closest possible contact of the upholstery covering 101, a linear-type connecting device 104 is provided which extends on one side into the transition regions parallel to the sidewalls 102 and on the other side transversely thereto over the concave region 103. Whereas a secure and reliable attachment of the upholstery covering 101 to the padded core is indeed hereby possible, the upholstery covering 101 is exposed in parts to a strong local pull whereby an evenly curved surface shape may be destroyed.

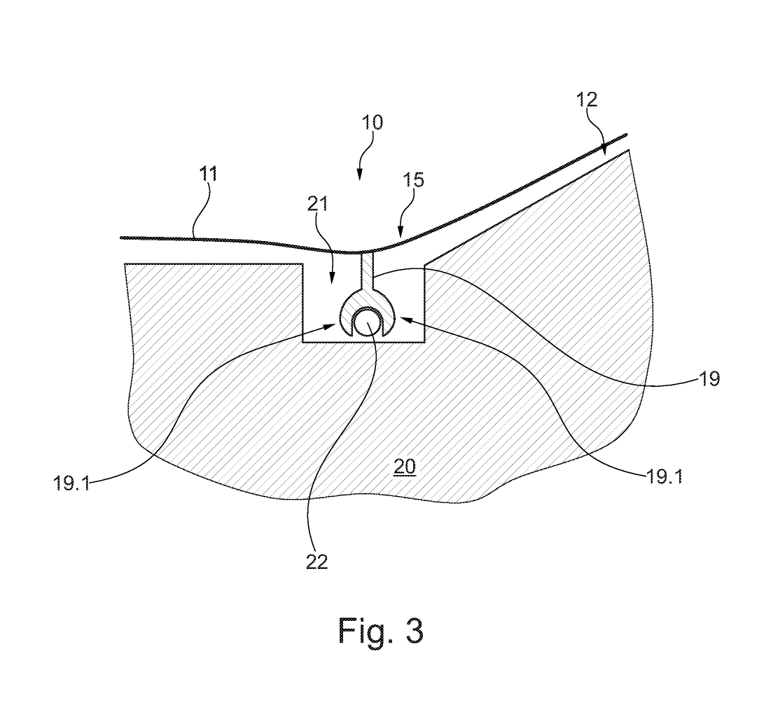

This problem experienced with the seat shown in FIG. 1 may be avoided at least in part with the backrest cushion 10 according to the embodiment shown in FIGS. 2-4. As seen in FIG. 2, the backrest cushion 10 is configured substantially like the backrest cushion 100 illustrated in FIG. 1, wherein more particularly a padded core 20 (visible in FIG. 3) of foam is configured practically identically. In particular, the padded core 20 has lateral sidewalls 12 between which a concave region 13 is formed. An upholstery covering 11 is arranged on the padded core 20. This covering is secured on the padded core 20 by means of three linear connecting devices 14, 15, 16. A first connecting device 14 and a second connecting device 15 extend at the sides in the transition region to the sidewalls 12 and run more or less parallel to one another. A third connecting device 16 extends transversely to the first and second connecting devices 14 and 15 over the concave region 13. The connecting devices 14, 15, 16 do not contact one another. Rather, a first end region 16.1 of the third connecting device 16 which is close to the first connecting device 14 is spaced from the first connecting device 14 by a connection-free region 17. An end region 14.1 of the first connecting device 14 which is close to the third connecting device 16 is correspondingly spaced from the first connecting device 16 by the connection-free region 17. In a corresponding way a second end region 16.2 of the third connecting device 16 which is close to the second connecting device 15 is spaced from the second connecting device 15 by a connection-free region 18. An end region 15.1 of the second connecting device 15 which is close to the third connecting device 16 is similarly spaced from the third connecting device 16 by the connection-free region 18. Since the individual regions 14.1, 15.1, 16.1, 16.2 do not contact one another, but connection-free regions 17, 18 are interposed between them, a harmonic surface profile can be achieved while at the same time a reliable attachment of the upholstery covering 11 on the padded core 20 is ensured. The extension of the connection-free regions 17, 18, and thus the spacing of the end regions 14.1, 16.1 and 15.1, 16.2 amounts in the present case to approximately twenty-five percent (25%) of the longitudinal extension of the second and third connecting device 14, 15, respectively, as well as approximately forty percent (40%) of the longitudinal extension of the third connecting device 16.

The connecting devices 14, 15, 16 illustrated herein can, like those in the other figures, be configured differently, according to other embodiments. An example is shown in FIG. 3 which gives a sectional view of a detail of FIG. 2. The padded core 20 has in the transition region to the sidewall 12 an elongated channel 21 which is shown herein with a rectangular cross-section but which can also have other shapes. A wire-like anchor element 22 is arranged in the elongated channel 21 and is connected to the padded core 20 via connecting elements which are not shown but which are cast in the foam matrix of the padded core 20. A clip element 19 is in turn fixedly connected to the upholstery covering 11, by way of example by stitching. The clip element 19 can be formed by way of example from plastic and has a certain elasticity. The clip element 19 engages with two elastic claws 19.1 in form-fitting connection around the anchor element 22 and secures the upholstery covering 11 to the padded core 20 in this way. Alternatively, however, other types of connections can also be selected. By way of example, instead of the clip element 19 a further wire-like element may be stitched on the upholstery covering 11 and is connected to the anchor element 22 by retaining rings.

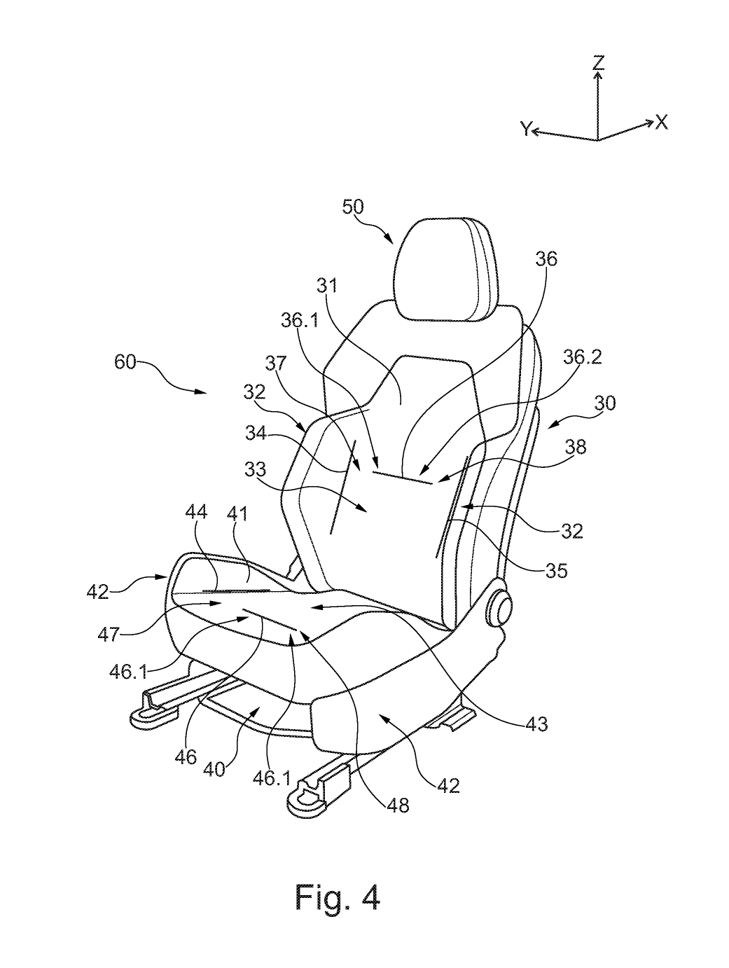

FIG. 4 shows in a perspective view a vehicle seat 60 with upholstered elements 30, 40 according to one embodiment. The general construction of the seat 60 does not differ from the prior art and is therefore not explained in detail. In addition to a headrest 50 which can be made in the conventional way, the vehicle seat 60 comprises a backrest cushion 30 as well as a seat cushion 40. The backrest cushion 30 has in turn sidewalls 32 arranged at the sides and between which a concave region 33 is formed. To connect an upholstery covering 31 to a padded core (not visible), a first connecting device 34 and a second connecting device 35 are arranged in the transition region to the sidewalls and extend substantially parallel to one another inside the X-Z plane. In between, a third connecting device 36 is arranged which runs parallel to the Y-axis. The three connecting devices 34, 35, 36 form an overall H-shaped structure in which a first end section 36.1 of the third connecting device 36 running towards the first connecting device 34 is spaced from the first connecting device 34 by a first connection-free region 37, and a first end section 36.2 of the third connecting device 36 running towards the second connecting device 35 is spaced from the second connecting device 35 by a second connection-free region 38. As already explained with reference to FIG. 2, the connection-free regions 37, 38 ensure an overall uniform curved surface area of the backseat cushion 30.

The seat cushion 40 likewise has lateral sidewalls 42 and a concave region 43 arranged in between the lateral sidewalls 42. Connecting devices are arranged in the transition regions to the sidewalls 42 for attaching an upholstery covering 41, of which only one connecting device 44 is visible here. A further connecting device 46 extends transversely to this inside the concave region 43. End regions 46.1, 46.2 of the connecting device 46 which approach the other connecting devices 44 are also spaced from these here by connection-free regions 47, 48.

It should be pointed out that the features as well as the measures detailed individually in the description can be combined with one another in any technically expedient manner, and provide further configurations of the invention. The description additionally characterizes and specifies the upholstered element more particularly in connection with the figures.

A padded element for a vehicle seat is provided in the present disclosure. The vehicle seat can more particularly be provided for a motor vehicle such as a passenger vehicle or goods vehicle but other applications are also conceivable by way of example for trains, boats or aircraft. The padded element has a padded core as well as an upholstery covering arranged thereon. The padded core ensures the actual normally elastic padding and can be made of by way of example, a foam material, thus a foamed polymer. The surface of the padded core is covered in the finished state at least partially or predominantly by the upholstery covering which can be made from material, leather, synthetic leather or other suitable materials. It is expressly possible that the upholstery covering is made up of several pieces which are by way of example stitched, welded or adhesively bonded to one another and overall form a type of cover for the padded core. The padded core can also include in some circumstances several pieces, but is normally, however, formed in one piece, according to one embodiment.

The padded core has a concave region in the embodiment shown and described herein. The term “concave” is here not to be understood solely in the strictly mathematical sense, but also in a wider sense that the surface of the material core has overall a groove and/or recoils inwards. One could also say that a concave region is then present between two points of the surface if all the interposed points of the surface lie further inwards relative to an imaginary level of connection, i.e., a concave region in this sense can also comprise where applicable smaller portions with straight or even convex surface. It is also possible that a region of this kind is saddle-shaped in the mathematical sense, thus is configured convex along one direction and concave transversely to this direction. In each case, it is such that in a concave region of this kind the upholstery covering in the stretched state normally then can follow only the form of the material core when it is fastened or secured inside the concave region.

This fastening is achieved in that the upholstery covering is connected to the padded core inside the concave region via at least two linear connecting devices, wherein at least an end region of one connecting device is close to another connecting device. The connecting devices thus produce the connection between the padded core and upholstery covering, wherein normally one part of each connecting device is assigned to the padded core and another part is assigned to the upholstery covering. In the embodiment shown, the connecting devices are linear, which means they are stretched longitudinally and have a significantly smaller extension across their running direction than along their running direction. The connecting devices need not be configured straight here, but can be bent or even angled per se, according to other embodiments. It is understood that the connecting devices are dimensioned so that the upholstery covering in the region of the respective connecting device bears relatively tightly against the padded core. It is then such that an end region of one connecting device is close to another connecting device. Since the connecting devices are linear, an end region of this kind is located at one end of a corresponding line. If now the end region is considered by itself, then this end region approaches the other connecting device. This can mean that the end region runs directly to the other connecting device, thus is certainly aligned to the other connecting device. In a further sense this means however that the outermost point of the end region is arranged closest to the other connecting device. If the one connecting device runs approximately in a straight line, then the statements relating to the end region obviously can be transferred to the entire connecting device, i.e., in this case it can be said that the entire connecting device is close to the other connecting device.

According to one embodiment, the end region is spaced from the other connecting device by a connection-free region, also feasible in a variation as individual connecting point(s). This means that the end region does not abut the other connecting device, but a connection-free region exists in between. It has been seen that in this way an always sufficient and secure attachment of the upholstery covering on the padded core can be achieved, although as a result of the connection-free region in which the upholstery covering is not forced against the padded core by a connecting device, a softer linear guide can be achieved overall which can have, in particular, a positive effect on the optical appearance, but can also where applicable improve the seat comfort and durability of the seat.

It is possible within the scope of the invention, even if rather unusual, that an end region of the one connecting device opposite the aforementioned end region is connected to the other connecting device, thus is not spaced by a connection-free region. A configuration of this kind is possible if at least one of the connecting devices changes direction within its profile.

According to one embodiment, the at least one end region runs at an angle to the other connecting device, i.e., the end region runs at an angle (thus at an angle other than zero) to the other connecting device. This can then be the case by way of example if the two connecting devices serve to enclose a part of the concave region. The first connecting device can be arranged by way of example on a first side of this enclosed part and the second connecting device can be arranged on a second side adjoining the latter. If the other connecting device does not run in a straight line, then the at least one end region can more particularly run at an angle to the part closest to it of the other connecting device.

At least one end region may run at an angle between thirty degrees (30°) and one hundred fifty degrees (150°) to the connecting device to which it approaches. The angle can further lie between fifty degrees (50°) and one hundred thirty degrees (130°). This is a configuration in which there is thus a clear difference between the alignment of the end region of the one connecting device and the other connecting devices. This is also a typical configuration which can result when, as illustrated above, a part of the concave region is enclosed by the connecting devices. The end region can more particularly approach the other connecting device more or less at right angles, thus for example at an angle between eighty degrees (80°) and one hundred degrees (100°).

In many cases the attachment of the upholstery covering to the padded core cannot be achieved with only two connecting devices. According to one configuration there are three connecting devices provided wherein each one end region of one connecting device is spaced from another connecting device by a connection-free region. Three connecting devices can be arranged by way of example around a part of the concave region and can enclose these as described above. Four connecting devices can also be provided more particularly in this case, according to another embodiment.

According to a specific configuration, a first and a second connecting device run at an angle of less than thirty degrees (30°) to one another and a third connecting device extends transversely to the first and second connecting devices, wherein the two end regions of the third connecting device approach the first and second connecting devices and are each spaced from these by connection-free regions. The first and second connecting devices can by way of example run parallel to one another or at least approximately parallel at least in some sections. They can more particularly run more or less inside the X-Z plane, thus the plane which is spanned by the X-axis (longitudinal axis) and the Z-axis (vertical axis of the vehicle. The third connecting device extends transversely to these and can by way of example run from a region adjoining the first connecting device to a region adjoining the second connecting device. More particularly the third connecting device can be arranged between the first and second connecting devices. In each case, the two end regions of this third connecting device approach the first and second connecting devices, respectively. They are however each still spaced apart and thus do not contact the connecting devices. The third connecting device runs more particularly approximately in the direction of the Y-axis (transverse axis) of the vehicle. An H-shaped structure can be formed overall wherein the third connecting device forms the H crossbar.

In order to achieve a noticeable improvement compared with an upholstered element having abutting or intermerging connecting devices, it is advantageous if the connection-free regions have a significant extension. More particularly an extension of a connection-free region can be at least five percent (5%) (any x-value), preferably at least ten percent (10%) (any x-value) of a length of a connecting device adjoining it. This can particularly apply to the connecting device whose end region comes close to adjoin the connection-free region of the other connecting device. The “extension of the connection-free region” refers here to the shortest distance between the end region and the other connecting device. In some circumstances it can also be expedient to provide an upper limit for the extension of the connection-free region, by way of example one hundred percent (100%) of the length of the adjoining connecting device. Whether and if such an upper limit is to be selected depends however on the relevant conditions of the upholstered element.

The connecting devices can be formed by different technical methods, wherein normally for reasons of efficiency the same technical method is used for all the connecting devices. In order to prevent the connecting devices from wearing out towards the outside, the padded core preferably has an indentation extending along a connecting device in which at least one anchor element is arranged which is connected to the padded core. An indentation of this kind which can also be termed a groove, flute or channel, thus serves to accommodate at least the anchor element which thus does not protrude to the outside. The cross-section of the indentation can be rectangular, circular or of another configuration. It is evident that such an indentation is normally introduced into the padded core directly as the latter is formed. The anchor element can be cast on the padded core during moulding directly or indirectly via an interposed further element, so that a part of the element is located inside the padded core and is enclosed for example by its foam matrix. The term “anchor element” means that this element serves to anchor the upholstery covering on the padded core.

By way of example, the anchor element can be configured as a wire. This can be a plastic or metal wire. The wire normally extends along the entire connecting device. Web elements which are moulded or connected to the wire in another way can extend from the wire and provide the connection with the padded core and are by way of example cast partially in the latter.

At least one restraining element which interacts with the anchor element may be connected to the upholstery covering. The restraining element forms the counter piece to the anchor element as regards the connection. Normally a form-locking engagement is produced by the anchor element and the restraining element. Thus, the restraining element can have, for example, claws or barbs which engage around a wire-shaped anchor element and thus produce a form-locking connection. It is also possible that a further wire is provided on the sides of the upholstery covering and is connected by clip rings to a wire on the sides of the padded core. The restraining element can be secured on the upholstery covering by different, more particularly, form-locking or material-bonding connections. More particularly, the restraining element can be stitched to the upholstery covering.

The upholstered element could be by way of example a headrest or armrest of a vehicle seat. The upholstered element is preferably however configured as a seat cushion or backrest cushion and the concave region is part of a seat surface. “Seat surface” here means the entire surface area which is provided as a support surface for a person sitting on the vehicle seat. Thus, in the case of a seat cushion it includes that part on which the person is actually sitting, and in the case of a backrest cushion it includes that part against which the person is leaning.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. An upholstered element for a vehicle seat, comprising:
a padded core having a concave region; and
an upholstery covering arranged on the core and connected inside the concave region to the padded core by way of at least two linear connecting devices, wherein at least one end region of one connecting device is close to another connecting device and is spaced from the other connecting device by a connection-free region and runs at an angle to the other connecting device.

2. The upholstered element as claimed in claim 1, wherein at least one end region runs at an angle of between 30° and 150° to the connecting device to which it is close.

3. The upholstered element as claimed in claim 1, wherein at least three connecting devices are provided wherein each one end region of one connecting device is spaced from another connecting device by a connection-free region.

4. The upholstered element as claimed in claim 1, wherein a first and a second connecting device run at an angle of less than 30° to one another and a third connecting device extends transversely to this, wherein the end regions on both sides of the third connecting device are close to the first and second connecting device and are spaced from these by connection-free regions.

5. The upholstered element as claimed in claim 1, wherein an extension of a connection-free region amounts to a least 5%, preferably at least 10% of a length of a connecting device adjoining it.

6. The upholstered element as claimed in claim 1, wherein the padded core has an indentation extending along a connecting device and in which at least one anchor element is arranged which is connected to the padded core.

7. The upholstered element as claimed in claim 6, wherein the at least one anchor element has a wire-like configuration.

8. The upholstered element as claimed in claim 6, wherein at least one restraining element interacting with the anchor element is connected to the upholstery covering.

9. The upholstered element as claimed in claim 1, wherein the upholstered element is configured as a seat cushion or as a backrest cushion and the concave region is part of a seat surface.

10. An upholstered vehicle seat element comprising:
a padded core having a concave region;
an upholstery covering arranged on the core; and
at least two linear connecting devices connecting the upholstery covering to the core inside the concave region, wherein an end region of one connecting device is close to another connecting device and is spaced from the other connecting device by a connection-free region and runs at an angle to the other connecting device.

11. The upholstered element as claimed in claim 10, wherein the end region runs at an angle of between 30° and 150° to the connecting device to which it is close.

12. The upholstered element as claimed in claim 10, wherein at least three connecting devices are provided wherein each one end region of one connecting device is spaced from another connecting device by a connection-free region.

13. The upholstered element as claimed in claim 10, wherein a first and a second connecting device run at an angle of less than 30° to one another and a third connecting device extends transversely to this, wherein the end regions on both sides of the third connecting device are close to the first and second connecting device and are spaced from these by connection-free regions.

14. The upholstered element as claimed in claim 10, wherein an extension of a connection-free region amounts to a least 5%, preferably at least 10% of a length of a connecting device adjoining it.

15. The upholstered element as claimed in claim 10, wherein the padded core has an indentation extending along a connecting device and in which at least one anchor element is arranged which is connected to the padded core.

16. The upholstered element as claimed in claim 15, wherein the at least one anchor element has a wire-like configuration.

17. The upholstered element as claimed in claim 15, wherein at least one restraining element interacting with the anchor element is connected to the upholstery covering.

18. The upholstered element as claimed in claim 10, wherein the upholstered element is configured as a seat cushion or as a backrest cushion and the concave region is part of a seat surface.
